(19) United States
(12) Patent Application Publication
(10) Pub. No.: US 2024/0392498 A1
(43) Pub. Date: Nov. 28, 2024

(54) WATER-REPELLENT POLYACRYLONITRILE-BASED ARTIFICIAL HAIR FIBER, METHOD FOR PRODUCING SAME, AND HEAD DECORATION PRODUCT

(71) Applicant: KANEKA CORPORATION, Osaka (JP)

(72) Inventors: Takaaki Kobashi, Hyogo (JP); Nobutaka Taoka, Hyogo (JP); Takeshi Tanaka, Hyogo (JP)

(73) Assignee: KANEKA CORPORATION, Osaka (JP)

(21) Appl. No.: 18/796,659

(22) Filed: Aug. 7, 2024

Related U.S. Application Data
(63) Continuation of application No. PCT/JP2023/012983, filed on Mar. 29, 2023.

(30) Foreign Application Priority Data
Mar. 30, 2022 (JP) 2022-057661
Jan. 31, 2023 (JP) 2023-013145

(51) Int. Cl. D06M 15/356; D01D 5/06; D01D 11/06; D01F 1/04; D01F 6/18; D06M 13/463; D06M 13/467; D06M 15/643; D06M 15/65

(52) U.S. Cl. CPC D06M 15/3568; D01D 5/06; D01D 11/06; D01F 6/18; D06M 13/463; D06M 13/467; D06M 15/6436; D06M 15/65; D01F 1/04; D10B 2321/10; D10B 2401/021; D10B 2401/16; D10B 2503/08

(57) ABSTRACT

A polyacrylonitrile-based artificial hair fiber having excellent water repellency and excellent tactile feel; a method for producing the fiber; and a head decoration product including the fiber are provided. The water-repellent polyacrylonitrile-based artificial hair fiber contains a polyacrylonitrile-based synthetic fiber (A). An alkyl (meth)acrylate-based water repellent (B) adheres to the polyacrylonitrile-based synthetic fiber (A). The alkyl (meth)acrylate-based water repellent (B) does not have a fluoro group. The alkyl (meth)acrylate-based water repellent (B) has a long-chain hydrocarbon side chain. The attached amount of the alkyl (meth)acrylate-based water repellent (B) is 0.03-1.0 mass % with respect to the total mass of the polyacrylonitrile-based synthetic fiber (A).

### TECHNICAL FIELD

One or more embodiments of the present invention relate to a water-repellent polyacrylonitrile-based artificial hair fiber, a method for producing the same, and a headdress product.

### BACKGROUND

In the related art, a fluorine-based water repellent having a fluorine-containing group has been known, and a fiber product whose surface is provided with water repellency by treating the fiber product or the like with such a fluorine-based water repellent has been known. Such a fluorine-based water repellent is generally produced by polymerizing or copolymerizing a monomer having a fluoroalkyl group. The fiber product treated with the fluorine-based water repellent exhibits a superior water repellency, but the monomer having a fluoroalkyl group is less likely to be decomposed, and thus places a large burden on the environment. Under such circumstances, in recent years, studies have been made on a non-fluorine-based water repellent containing no fluorine. For example, Patent Document 1 describes that a fiber product obtained by treating a nylon cloth or a polyester cloth with a specific non-fluorine-based water repellent has a sufficient water repellency and a durable water repellency.

### Patent Document

Patent Document 1: Japanese Unexamined Patent Application, Publication No. 2017-210704

A polyacrylonitrile-based synthetic fiber is used as an artificial hair fiber because it has texture similar to human hair, and there is a demand for providing a water repellency to the polyacrylonitrile-based artificial hair fiber as well. Therefore, in order to achieve such a purpose, a method of treatment with the non-fluorine-based water repellent is considered. However, when the polyacrylonitrile-based synthetic fiber is treated with the non-fluorine-based water repellent, the water repellency is improved, but the texture inherent to the polyacrylonitrile-based synthetic fiber is impaired.

One or more embodiments of the present invention has been made in view of the above, and provide a polyacrylonitrile-based artificial hair fiber that is superior in water repellency and texture, a method for producing the fiber, and a headdress product containing the fiber.

The present inventors have found that the above can be addressed by using a specific non-fluorine-based water repellent and intensively studying an amount of the non-fluorine-based water repellent attached, and have completed one or more embodiments of the present invention.

### SUMMARY

One or more embodiments of the present invention relate to a water-repellent polyacrylonitrile-based artificial hair fiber including a polyacrylonitrile-based synthetic fiber (A), in which an alkyl (meth)acrylate-based water-repellent (B) is attached to the polyacrylonitrile-based synthetic fiber (A), a method for producing the fiber, and a headdress product including the fiber.
[1] A water repellent polyacrylonitrile-based artificial hair fiber including a polyacrylonitrile-based synthetic fiber (A), and
an alkyl (meth)acrylate-based water repellent (B) attached to the polyacrylonitrile-based synthetic fiber (A), the alkyl (meth)acrylate-based water repellent (B) not having a fluorine group,
the alkyl (meth)acrylate-based water repellent (B) having a long-chain hydrocarbon side chain,
an amount of the alkyl (meth)acrylate-based water repellent (B) attached being 0.03 mass % or more and 1.0 mass % or less with respect to a total mass of the polyacrylonitrile-based synthetic fiber (A).
[2] The water repellent polyacrylonitrile-based artificial hair fiber as described in [1], further including a modified silicone (C) having a polar substituent and being attached to the polyacrylonitrile-based synthetic fiber (A), in which
the modified silicone (C) is a dimethylsiloxane polymer substituted with an epoxy group and/or an amino group, and an amount of the modified silicone (C) attached is 0.01 mass % or more and 0.5 mass % or less with respect to the total mass of the polyacrylonitrile-based synthetic fiber (A).
[3] The water repellent polyacrylonitrile-based artificial hair fiber as described in [1] or [2], in which the alkyl (meth)acrylate-based water repellent (B) further includes a structural unit derived from vinyl chloride.

[4] The water repellent polyacrylonitrile-based artificial hair fiber as described in any one of [1] to [3], in which an ionic antistatic agent (D1) and/or a nonionic antistatic agent (D2) are/is further attached, as an antistatic agent (D), to the polyacrylonitrile-based synthetic fiber (A), and
an amount of the antistatic agent (D) attached is 0.05 mass % or more and 0.4 mass % or less with respect to the total mass of the polyacrylonitrile-based synthetic fiber (A).
[5] The water repellent polyacrylonitrile-based artificial hair fiber as described in any one of [2] to [4], in which a mass ratio of an amount of the alkyl (meth)acrylate-based water repellent (B) attached relative to an amount of the modified silicone (C) attached, (B):(C), ranges between 1:0.03 and 1:0.4 inclusive.
[6] The water repellent polyacrylonitrile-based artificial hair fiber as described in [4] or [5], in which a mass ratio of the amount of the alkyl (meth)acrylate-based water repellent (B) attached relative to an amount of the antistatic agent (D) attached, (B):(D), ranges between 1:0.15 and 1:0.7 inclusive.
[7] The water repellent polyacrylonitrile-based artificial hair fiber as described in any one of [4] to [6], in which a mass ratio of the amount of the alkyl (meth)acrylate-based water repellent (B) attached relative to the amount of the modified silicone (C) attached, (B):(C), ranges between 1:0.03 and 1:0.4 inclusive, and
a mass ratio of the amount of the alkyl (meth)acrylate-based water repellent (B) attached relative to the amount of the antistatic agent (D) attached, (B):(D), ranges between 1:0.15 and 1:0.7 inclusive.
[8] The water repellent polyacrylonitrile-based artificial hair fiber as described in any one of [1] to [7], in which a single fiber fineness is 1 dtex or more and 100 dtex or less.
[9] A method of producing the water repellent polyacrylonitrile-based artificial hair fiber as described in any one of [1] to [8], the method including:
obtaining a coagulated yarn by wet spinning a spinning solution containing an acrylonitrile-based polymer, and bringing the yarn to be treated before drying into contact with an oil agent containing the alkyl (meth)acrylate-based water repellent (B).
[10] A method of producing the water repellent polyacrylonitrile-based artificial hair fiber as described in any one of [1] to [8], the method including:
bringing a dried polyacrylonitrile-based synthetic fiber (A) into contact with an oil agent containing the alkyl (meth)acrylate-based water repellent (B); and drying a thread after the contact treatment.

A headdress product including the water repellent polyacrylonitrile-based artificial hair fiber as described in any one of [1] to [8].

The headdress product as described in [11], in which the headdress product is at least one selected from the group consisting of a hair wig, a hairpiece, a weaving, a hair extension, a braid hair, a hair accessory, and a doll hair.

According to one or more embodiments of the present invention, it is possible to provide a polyacrylonitrile-based artificial hair fiber that is superior in water repellency and texture, a method for producing the fiber, and a headdress product containing the fiber.

### DETAILED DESCRIPTION

### Water-repellent Polyacrylonitrile-based Artificial Hair Fiber

The water-repellent polyacrylonitrile-based artificial hair fiber includes a polyacrylonitrile-based synthetic fiber (A). In the water-repellent polyacrylonitrile-based artificial hair fiber, an alkyl (meth)acrylate-based water repellent (B) is attached to the polyacrylonitrile-based synthetic fiber (A), and an amount of the alkyl (meth)acrylate-based water repellent (B) attached is 0.03 mass % or more and 1.0 mass % or less with respect to a total mass of the polyacrylonitrile-based synthetic fiber (A). More specifically, in the water-repellent polyacrylonitrile-based artificial the alkyl hair fiber, (meth)acrylate-based water repellent (B) is attached to a surface of the polyacrylonitrile-based synthetic fiber (A) to form a film. Due to the alkyl (meth)acrylate-based water repellent (B) being attached to the polyacrylonitrile-based synthetic fiber (A) in a specific amount, the water-repellent polyacrylonitrile-based artificial hair fiber also exhibits an effect of being superior in water repellency and texture, even when the modified silicone (C) having a polar substituent, which will be described later, is not attached to the polyacrylonitrile-based synthetic fiber (A).

Hereinafter, essential or optional components contained in the water-repellent polyacrylonitrile-based artificial hair fiber will be described.

### (Polyacrylonitrile-Based Synthetic Fiber (A))

An acrylonitrile-based polymer constituting the polyacrylonitrile-based synthetic fiber (A) is not particularly limited as long as it contains 25 mass % or more of a constituent unit derived from acrylonitrile, and for example, an acrylonitrile-based polymer containing 25 mass % to 100 mass % of a constituent unit derived from acrylonitrile and 0 mass % to 75 mass % of a constituent unit derived from another monomer can be used. The acrylonitrile-based polymer may contain 95 mass % or less of the constituent unit derived from acrylonitrile and 5 mass % or more of the constituent unit derived from another monomer, may contain 90 mass % or less of the constituent unit derived from acrylonitrile and 10 mass % or more of the constituent unit derived from another monomer, and may contain 30 mass % to less than 85 mass % of the constituent unit derived from acrylonitrile and more than 15 mass % and 70 mass % or less of the constituent unit derived from another monomer.

The another monomer is not particularly limited as long as it is copolymerizable with acrylonitrile, and examples thereof include unsaturated carboxylic acids such as acrylic acid and methacrylic acid and salts thereof, acrylate esters such as methyl acrylate, methacrylic esters such as methyl methacrylate, esters of unsaturated carboxylic acids such as glycidyl methacrylate, vinyl esters such as vinyl acetate and vinyl butyrate, halogen-containing monomers, and sulfonic acid group-containing monomers. These may be used alone or may be used in combination of two or more thereof.

The acrylonitrile-based polymer may contain 30 mass % to 80 mass % of the constituent unit derived from acrylonitrile, 20 mass % to 70 mass % of a constituent unit derived from a halogen-containing monomer, and 0 mass % to 5 mass % of a constituent unit derived from a sulfonic acid group-containing monomer, from the viewpoint of heat resistance, flame resistance, and dyeability. The acrylonitrile-based polymer may contain 35 mass % to 75 mass % of the constituent unit derived from acrylonitrile, 25 mass % to 65 mass % of the constituent unit derived from the halogen-containing monomer, and 0 mass % to 5 mass % of the constituent unit derived from the sulfonic acid group-containing monomer, and may contain 35 mass % to 75 mass % of the constituent unit derived from acrylonitrile, 24.5 mass % to 64.5 mass % of the constituent unit derived from the halogen-containing monomer, and 0.5 mass % to 5 mass % of the constituent unit derived from the sulfonic acid group-containing monomer.

Examples of the halogen-containing monomer include halogen-containing vinyl monomers such as vinyl chloride and vinyl bromide, and halogen-containing vinylidene monomers such as vinylidene chloride and vinylidene bromide. The halogen-containing monomer may be used alone or may be used in combination of two or more thereof. The halogen-containing monomer may contain at least one selected from the group consisting of vinyl chloride and vinylidene chloride, or may contain vinyl chloride from the viewpoint of texture.

The sulfonic acid group-containing monomer is not particularly limited, and examples thereof include allylsulfonic acid, methallylsulfonic acid, styrenesulfonic acid, isoprenesulfonic acid, 2-acrylamido-2-methylpropanesulfonic acid, metal salts such as sodium salts thereof, and amine salts thereof. The sulfonic acid group-containing monomer may be used alone or may be used in combination of two or more thereof.

A single fiber fineness of the polyacrylonitrile-based synthetic fiber (A) is not particularly limited, and may be, for example, 1 dtex or more and 100 dtex or less, and the single fiber fineness may be 10 dtex or more and 90 dtex or less, 20 dtex or more and 80 dtex or less, 30 dtex or more and 70 dtex or less, or 35 dtex or more and 65 dtex or less, from the viewpoint of suitable use as synthetic hair.

A method for producing the polyacrylonitrile-based synthetic fiber (A) is not particularly limited, and the polyacrylonitrile-based synthetic fiber (A) can be produced by using, for example, a wet spinning method. The wet spinning method is a method in which a spinning raw solution made of the acrylonitrile-based polymer is extruded from a spinning nozzle into a coagulation bath and coagulated in the coagulation bath to form a thread. In addition, the wet spinning method may include any one of a water washing step, a drying step, a stretching step, and a thermal relaxation step in addition to the coagulation step.

The polyacrylonitrile-based synthetic fiber (A) may be produced by using the above-described method, or a commercially available polyacrylonitrile-based synthetic fiber may be obtained. Examples of the commercially available product of the polyacrylonitrile-based synthetic fiber (A) include “AFRELLE” and “SYC” manufactured by Kaneka Corporation.

(Alkyl (Meth) acrylate-Based Water Repellent (B))

The alkyl (meth)acrylate-based water repellent (B) can be used as a non-fluorine-based water repellent. Therefore, the alkyl (meth)acrylate-based water repellent (B) does not have a fluorine group. The alkyl (meth)acrylate-based water repellent (B) is a polymer containing an acrylate ester and/or a methacrylate ester and a structural unit derived from a monomer copolymerizable therewith. The alkyl (meth)acrylate-based water repellent (B) has a long-chain hydrocarbon side chain on a side chain of the structural unit or separately from the structural unit. The long-chain hydrocarbon side chain may be a linear alkyl group having 12 to 24 carbon atoms, or a linear alkyl group having 16 to 22 carbon atoms.

The alkyl (meth)acrylate-based water repellent (B) may contain a structural unit derived from another monomer. Examples of the another monomer include halogenated olefins such as vinyl chloride, vinyl bromide, vinyl iodide, vinylidene chloride, vinylidene bromide, and vinylidene iodide. Among these, those containing a structural unit derived from vinyl chloride are preferable. Examples of commercially available products of the alkyl (meth)acrylate-based water repellent (B) include “NEOSEED NR 7080” manufactured by Nicca Chemical Co., Ltd.

An amount of the alkyl (meth)acrylate-based water repellent (B) attached may be 0.03 mass % or more and 1.0 mass % or less, 0.05 mass % or more and 0.75 mass % or less, or 0.1 mass % or more and 0.6 mass % or less, with respect to a total mass of the polyacrylonitrile-based synthetic fibers (A), from the viewpoint of providing excellent water repellency and excellent texture to the polyacrylonitrile-based artificial hair fiber.

In the present specification, “(meth) acrylate” means both “acrylate” and “methacrylate”, and “(meth) acrylic acid” means both “acrylic acid” and “methacrylic acid”.

### (Other Components)

The polyacrylonitrile-based artificial hair fiber may contain components other than the polyacrylonitrile-based synthetic fiber (A) and the alkyl (meth)acrylate-based water repellent (B) (hereinafter also referred to as “other components”) as long as the effect of one or more embodiments of the present invention are not impaired. Examples of the other components include: a modified silicone; an antistatic agent; a water-repellent aid; a gloss adjusting agent; a coloring agent such as an organic pigment, an inorganic pigment, and a dye; a light stabilizer; a thermal stabilizer; a fiber-converging agent; a deodorant; a fragrance; an insect repellent; an antibacterial agent; and a crosslinking agent.

(Modified Silicone (C) having Polar Substituent)

The modified silicone (C) having a polar substituent is a silicone having a substituent obtained by substituting any portion of a polydialkylsiloxane skeleton, preferably a polydimethylsiloxane skeleton (hereinafter, also collectively referred to as “polysiloxane”) of the silicone, and includes modified silicones obtained by modifying one terminal, both terminals, or a side chain of a straight-chain or branched polysiloxane, and a crosslinking type modified silicone obtained by crosslinking these.

The modified silicone (C) is not particularly limited, and examples thereof include epoxy-modified silicone, amino- modified silicone, mercapto-modified silicone, carboxyl-modified silicone, hydrogen-modified silicone, and methacrylic-modified silicone. These may be used alone or may be used in combination of two or more thereof.

Of these, the preferred are epoxy-modified silicone and amino-modified silicone, from the viewpoint that the polyacrylonitrile-based artificial hair fiber is superior in water repellency and texture due to use of the alkyl (meth)acrylate-based water repellent (B) in combination.

Examples of a commercially available product of the epoxy-modified silicone include “POLIN-MF-18T” manufactured by Shin-Etsu Chemical Co., Ltd. Examples of a commercially available product of the amino-modified silicone include “POLIN-MF-63” manufactured by Shin-Etsu Chemical Co., Ltd.

An amount of the modified silicone (C) attached may be 0.01 mass % or more and 0.5 mass % or less, 0.01 mass % or more and 0.3 mass % or less, or 0.02 mass % or more and 0.2 mass % or less, with respect to the total mass of the polyacrylonitrile-based synthetic fiber (A), from the viewpoint of making the polyacrylonitrile-based artificial hair fiber excellent in water repellency and also excellent in texture.

### (Antistatic Agent (D))

An antistatic agent (D) is not particularly limited, and examples thereof include an ionic antistatic agent (D1) and a nonionic antistatic agent (D2).

Examples of the ionic antistatic agent (D1) include anionic antistatic agents such as higher fatty acid salts, higher alcohol sulfate ester salts, sulfated oils, and sulfonates; cationic antistatic agents such as alkyl amine salts, quaternary ammonium salts, imidazolinium salts, and guanidine salts; and amphoteric antistatic agents such as amine oxide type and betaine type antistatic agents.

Examples of the nonionic antistatic agent (D2) include nonionic antistatic agents such as polyoxyethylene alkyl ether type, polyhydric alcohol fatty acid ester type, polyoxyethylene polyhydric alcohol fatty acid ester type, fatty acid alkanolamide type, polyoxyethylene alkyl amine type, and polyalkylene glycol.

The antistatic agent (D) may be used alone or may be used in combination of two or more thereof.

Of these, the preferred is the cationic antistatic agent (D1) and/or the nonionic antistatic agent (D2), from the viewpoint that the polyacrylonitrile-based artificial hair fiber is superior in water repellency and texture.

An amount of the antistatic agent (D) attached can be appropriately selected within a range that does not impair the water repellency and texture, and may be 0.05 mass % or more and 0.4 mass % or less, or 0.05 mass % or more and 0.2 mass % or less with respect to the total mass of the polyacrylonitrile-based synthetic fiber (A), from the viewpoint of reducing static electricity.

A mass ratio of the amount of the alkyl (meth)acrylate-based water repellent (B) attached relative to the amount of the modified silicone (C) attached, (B):(C), may range between 1:0.03 and 1:0.4 inclusive, between 1:0.03 and 1:0.3 inclusive, or between 1:0.04 and 1:0.2 inclusive, from the viewpoint of being superior in water repellency and texture.

A mass ratio of the amount of the alkyl (meth)acrylate-based water repellent (B) attached relative to the amount of the antistatic agent (D) attached, (B):(D), may range between 1:0.15 and 1:0.7 inclusive, between 1:0.15 and 1:0.6 inclusive, or between 1:0.2 and 1:0.5 inclusive.

When the static electricity is strongly generated, a trouble is likely to occur in a spinning step or a processing.

### (Water-Repellent Aid (E))

The water-repellent aid (E) refers to a modified silicone having a non-polar substituent. The water-repellent aid (E) is not particularly limited, and examples thereof include an alkyl-modified silicone, an aryl-modified silicone, and an aralkyl-modified silicone. An alkyl group of the alkyl-modified silicone may be an alkyl group having 8 to 24 carbon atoms, and or an alkyl group having 12 to 22 carbon atoms. These may be used alone or in combination of two or more.

Among these, the alkyl-modified silicone is preferred because it can be used in combination with the alkyl (meth)acrylate-based water repellent (B) to impart excellent water repellency to polyacrylonitrile-based artificial hair fibers.

Examples of commercially available alkyl-modified silicones include “X-52-8046” manufactured by Shin-Etsu Chemical Co., Ltd.

An amount of the water repellent aid (E) attached may be appropriately selected within a range not to impair water repellency and texture, and may be 0.01 mass % or more and 0.2 mass % or less or 0.01 mass % or more and 0.1 mass % or less, with respect to the total mass of the polyacrylonitrile-based synthetic fiber (A).

### Method 1 for Producing Water-Repellent Polyacrylonitrile-Based Artificial Hair Fiber

A first aspect of a method for producing the water-repellent polyacrylonitrile-based artificial hair fiber includes: obtaining a coagulated yarn by wet-spinning a spinning solution containing an acrylonitrile-based polymer; and bringing the yarn to be treated before drying into contact with an oil agent containing the alkyl (meth)acrylate-based water repellent (B).

According to the production method of the present aspect, as described above, it is possible to produce a water-repellent polyacrylonitrile-based artificial hair fiber that is superior in water repellency and texture.

Hereinafter, a step of obtaining a coagulated yarn by wet-spinning a spinning solution containing an acrylonitrile-based polymer (hereinafter, also referred to as a “coagulation step”), a step of bringing the yarn to be treated before drying into contact with an oil agent containing the alkyl (meth)acrylate-based water repellent (B) (hereinafter, also referred to as a “contact step”), and any optional step will be described.

### <Coagulation Step>

### (Acrylonitrile-Based Polymer)

The acrylonitrile-based polymer is a raw material for producing a yarn of the polyacrylonitrile-based synthetic fiber (A). The acrylonitrile-based polymer is the same as that of one or more embodiments of the acrylonitrile-based polymer described in the item of “Polyacrylonitrile-Based Synthetic Fiber (A)”.

### (Spinning Solution)

The spinning solution contains the acrylonitrile-based polymer and an organic solvent. The organic solvent is not particularly limited, and it is preferred to use a good solvent for the acrylonitrile-based polymer. Examples of the good solvent for the acrylonitrile-based polymer include dimethyl sulfoxide (DMSO), N, N-dimethylacetamide (DMAc), N, N-dimethylformamide (DMF), and acetone. Of these, acetone may be used from the viewpoint of versatility. In addition, dimethyl sulfoxide may be used from the viewpoint of high safety. The spinning solution may contain a small amount of water, for example, water of 1.5 mass % or more and 4.8 mass % or less. Accordingly, voids can be prevented from being formed.

### (Other Additives)

The spinning solution may contain other additives for improving fiber characteristics, if necessary, within a range that does not impair the effect of one or more embodiments of the present invention. Examples of the other additives include a gloss adjusting agent, an organic pigment, an inorganic pigment, a coloring agent such as a dye, and a stabilizer for improving light resistance or heat resistance.

### (Coagulation Step)

The coagulation step is a step of discharging the above-described spinning solution through a spinning nozzle into a coagulation solution (coagulation bath) and coagulating the same to form a thread (hereinafter, such a yarn is also referred to as a “coagulated yarn”). An operation of the coagulation step is not particularly limited, and may be, for example, a wet spinning method in which a spinning solution in a raw solution tank is directly discharged into a coagulation solution according to an ordinary method. In addition, the operation of the coagulation step may be a dry-wet spinning method in which the spinning solution is once discharged into the air from the spinning nozzle and then introduced into the coagulation solution.

A temperature of the spinning solution is not particularly limited as long as it is a temperature at which the spinning solution can be stably maintained without being changed over time in the raw solution tank, and for example, may usually be 40° C. or higher and 70° C. or lower.

A composition of the coagulation solution is not particularly limited, and for example, an aqueous solution of a good solvent such as acetone may be used. A concentration of the good solvent is not particularly limited, and may be, for example, 10 mass % or more and 70 mass % or less. If the concentration is less than 10 mass %, coagulation becomes rapid, a coagulation structure becomes coarse, and voids tend to be formed inside the fibers.

A temperature of the coagulation solution is not particularly limited, and may be, for example, 5° C. or higher and 40° C. or lower.

The spinning nozzle can be appropriately used in accordance with an intended fiber cross section. The fiber cross section is not particularly limited, and may be any cross section such as circular, elliptical, and irregular shape.

An amount of the spinning solution discharged from the spinning nozzle is not particularly limited, and may be, for example, 0.1 g/min or more as a single-hole discharge amount. A spinning speed of the spinning solution from the spinning nozzle is not particularly limited, and may be 2 m/min or more and 17 m/min or less from the viewpoint of industrial productivity.

The coagulated yarn (fiber) that passes through the coagulation solution is wound up by a winding roller via a feed roller, for example, according to an ordinary method, thereby obtaining an unstretched yarn. In addition, the coagulated yarn (fiber) may be continuously advanced to other steps without being wound up.

### (Other Steps)

The wet spinning may include steps other than the coagulation step (hereinafter, also referred to as “other steps”) as long as the effect of one or more embodiments of the present invention is not impaired. Examples of the other steps include a water washing step, a drying step, a stretching step, and a thermal relaxation treatment step.

Examples of the stretching step include a wet stretching step performed before the water washing step or after the water washing step and before the drying step, and a dry stretching step performed after the drying step.

An order of the steps is not particularly limited, and examples thereof include a method in which a wet stretching step, a water washing step, a drying step, a dry stretching step, and a thermal relaxation treatment step are sequentially performed after a coagulation step, and a method in which a water washing step, a wet stretching step, a drying step, a dry stretching step, and a thermal relaxation treatment step are sequentially performed after a coagulation step.

### (Wet Stretching Step)

The wet stretching step is a step of stretching the coagulated yarn in a stretching bath (hereinafter, also referred to as “primary stretching”). It is preferable to use an aqueous solution having a lower concentration of a good solvent such as acetone in the stretching bath than in the coagulation bath. A temperature of the stretching bath i may be 30° C. or higher, or 40° C. or higher. A stretching ratio is not particularly limited, and may be 1.5 times or more and 8 times or less, from the viewpoint of improving strength and productivity of the fibers. When the primary stretching is performed using a water bath, the wet stretching step may be performed after the water washing step to be described later, or the primary stretching and the water washing may be performed simultaneously.

### (Water Washing Step)

The water washing step is a step of removing a good solvent such as acetone attached to the yarn which has been subjected to the coagulation step or the wet stretching step. In the water washing step, from the viewpoint of easily removing the good solvent, it is preferred to use hot water of 70° C. or higher, for example.

### (Drying Step)

The drying step is a step of densifying the yarn by drying the yarn. A drying temperature is not particularly limited, and may be, for example, 110° C. or higher and 190° C. or lower.

### (Dry Stretching Step)

The dry stretching step is a step of stretching the yarn under heating conditions (hereinafter, also referred to as “secondary stretching”). A stretching temperature is not particularly limited, and may be, for example, 110° C. or higher and 190° C. or lower. A stretching ratio is not particularly limited, and may be, for example, 1 time or more and 4 times or less, 1.5 times or more and 3.5 times or less, or 1.5 times or more and 3 times or less.

A total stretching ratio including wet stretching before drying may be 2 times or more and 10 times or less, 2 times or more and 8 times or less, 2 times or more and 6 times or less, or 2 times or more and 4 times or less.

### (Thermal Relaxation Treatment Step)

The thermal relaxation treatment step is a step of relaxing the yarn after being dry-stretched in a high temperature atmosphere. A relaxation ratio is not particularly limited, and may be, for example, 5% or more, or 8% or more and 20% or less. The thermal relaxation treatment can be performed, for example, in a dry heat atmosphere of 140° C. or higher and 200° C. or lower or in a superheated steam atmosphere.

### <Contact Step>

(Yarn to be Treated before Drying)

The yarn to be treated before drying is a yarn that is not dried and therefore is not densified, and is a yarn that is brought into contact with an oil agent to be described later. The yarn to be treated includes, in addition to the coagulated yarn obtained by the wet spinning, yarns that that have been subjected to treatments other than the drying step, dry stretching step, or thermal relaxation treatment step described above. Specifically, the yarns to be treated include the coagulated yarn obtained by the wet spinning, a yarn that is wet-stretched, and a yarn that is washed with water. Of these, the preferred is the yarn that is washed with water from the viewpoint of preventing an organic solvent from being mixed into the oil agent.

### (Oil Agent)

The oil agent contains the above-described alkyl (meth)acrylate-based water repellent (B). The oil agent may be used as a mixed solution in which the alkyl (meth)acrylate-based water repellent (B) is dispersed or dissolved in water.

The oil agent may contain components other than the alkyl (meth)acrylate-based water repellent (B) and water (hereinafter, also referred to as “other components”) as long as the effect of one or more embodiments of the present invention is not impaired. Examples of the other components include: a modified silicone; an antistatic agent; a water-repellent aid; a gloss adjusting agent; a coloring agent such as an organic pigment, an inorganic pigment, and a dye; a light stabilizer; a thermal stabilizer; a fiber-converging agent; a deodorant; a fragrance; an insect repellent; an antibacterial agent; and a crosslinking agent.

Of these, the modified silicone, the antistatic agent, and the water-repellent aid are the same as those of one or more embodiments described in the items of “(Modified Silicone (C))”, “(Antistatic Agent (D))”, and “(Water-Repellent Aid (E))”.

### (Contact Method)

A method of bringing a yarn to be treated into contact with an oil agent is not particularly limited, and examples thereof include an immersion method, a spraying method with a spray, a spread method with a shower, and an apply method. Of these, the preferred is the immersion method from the viewpoint of uniformly bringing the yarn to be treated into contact with each component contained in the oil agent.

A contact temperature is not particularly limited, and can be appropriately adjusted to 40° C. or higher and 90° C. or lower in accordance with a state of the yarn to be treated or an intended amount of attached.

A contact time is also not particularly limited, and can be appropriately adjusted to 1 second or longer and 10 minutes or shorter in accordance with the state of the yarn to be treated or the intended amount of attached.

In one or more embodiments, it is preferred to dry the thread after the contact treatment and then dry-stretch the same. By going through such a step, it is possible to produce the water-repellent polyacrylonitrile-based artificial hair fiber that is superior in the water repellency and the texture.

### Method 2 for Producing Water-Repellent Polyacrylonitrile-Based Artificial Hair Fiber

A second embodiment of a method for producing a water-repellent polyacrylonitrile-based artificial hair fiber includes: bringing a dried polyacrylonitrile-based synthetic fiber (A) into contact with an oil agent containing the alkyl (meth)acrylate-based water repellent (B); and drying the thread after the contact treatment.

According to the production method of one or more embodiments, as described above, it is possible to produce the water-repellent polyacrylonitrile-based artificial hair fiber that is superior in the water repellency and the texture.

Hereinafter, a step of bringing the dried polyacrylonitrile-based synthetic fiber (A) with the oil agent containing the alkyl (meth)acrylate-based water repellent (B) (hereinafter, also referred to as a “contact step”), a step of drying the thread after the contact treatment (hereinafter, also referred to as a “drying step”), and any step will be described.

### <Contact Step>

The polyacrylonitrile-based synthetic fiber (A) is the same as that of one or more embodiments described in the item of “Polyacrylonitrile-Based Synthetic Fiber (A)”.

The dried polyacrylonitrile-based synthetic fiber (A) is obtained by, for example, drying the polyacrylonitrile-based synthetic fiber (A) at room temperature or higher and 190° C. or lower.

The oil agent containing the alkyl (meth)acrylate-based water repellent (B) is the same as that of one or more embodiments described in the item “(Oil Agent)”.

The method of bringing the dried polyacrylonitrile-based synthetic fiber (A) into contact with the oil agent is the same as that of one or more embodiments described in the item “(Contact Method)”.

However, in the present production method 2, the dried polyacrylonitrile-based synthetic fiber (A) is used as a raw material, and thus the components contained in the oil agent are less likely to be attached to the polyacrylonitrile-based synthetic fiber (A). Therefore, it is preferred that the contact time is set to be longer than the contact time described in the

### Method 1 for Producing Water-Repellent Polyacrylonitrile-Based Artificial Hair Fiber

### <Drying Step>

The drying step is a step of drying the thread of the polyacrylonitrile-based synthetic fiber (A) after the contact treatment to densify the yarn. A drying temperature is not particularly limited, and may be, for example, 110° C. or higher and 190° C. or lower.

### (Other Steps)

The present production method 2 may include a step other than the contact step and the drying step (hereinafter, also referred to as “other steps”) as long as the effect of one or more embodiments of the present invention is not impaired. Examples of the other steps include a stretching step and a thermal relaxation treatment step. The stretching step and the thermal relaxation treatment step are the same as those of one or more embodiments described in the items “(Stretching Step)” and “(Thermal Relaxation Treatment Step)”.

### Headdress Product

The headdress product contains the above-described water-repellent polyacrylonitrile-based artificial hair fiber.

The headdress product is not particularly limited, and examples thereof include a hair wig, a hairpiece, a weaving, a hair extension, a braid hair, a hair accessory, and a doll hair. The water-repellent polyacrylonitrile-based artificial hair fiber may be used alone as synthetic hair to constitute a headdress product. Alternatively, in addition to the water-repellent polyacrylonitrile-based artificial hair fiber, other artificial hair fibers and natural fibers such as human hair and animal hair may be combined to constitute a headdress product. The other artificial hair fibers are not particularly limited, and examples thereof include polyvinyl chloride-based fibers, nylon fibers, polyester fibers, and regenerated collagen fibers.

### EXAMPLES

Hereinafter, one or more embodiments of the present invention will be described in more detail based on Examples and Comparative Examples, and one or more embodiments of the present invention are not limited to the following Examples.

### Examples 1 to 8 and Comparative Examples 1 to 2

### Preparation of Oil Agent

The following water repellent (B), the following modified silicone (C), the following antistatic agent (D), the following water-repellent aid (E), and water were mixed in contents described in the following Table 1 to prepare oil agents 1 to 8 and comparative oil agents 1 to 2, which are oil agent aqueous solutions.

Incidentally, the oil agents 1 and 2 are the same compositions and the oil agents 3 and 4 are also the same compositions in Table 1. As will be described later, when preparing a water-repellent polyacrylonitrile-based artificial hair fiber, the oil agents 1 and 2 or 3 and 4 are, however, applied in different application methods, A and B, to the polyacrylonitrile-based synthetic fiber (A). Thus, different oil agent numbers are used for convenience.

As the water repellent (B), the following B1 and B2 were used.
B1: alkyl acrylate-based water repellent (“NEOSEED NR-7080”, manufactured by Nicca Chemical Co., Ltd.)

As the modified silicone (C), the following C1 to C2 were used.
C1: epoxy-modified silicone (“POLON-MF-18T”, manufactured by Shin-Etsu Chemical Co., Ltd.)
C2: amino-modified silicone (“POLON-MF-63”, manufactured by Shin-Etsu Chemical Co., Ltd.)

As the antistatic agent (D), the following D1 was used. D1: quaternary ammonium salt

As the water-repellent aid (E), the following E1 was used. E1: alkyl-modified silicone

TABLE 1

| | | | | Water | | |
|---|---|---|---|---|---|---|
| | Water | Modified | Antistatic | repellent | | Method of |
| | repellent (B) | silicone (C) | agent (D) | aid (E) | Water | applying |
| | Type/mass % | Type/mass % | Type/mass % | Type/mass % | Mass % | oil agent |
| Oil agent 1 | B1/1.3 | — | D1/0.50 | E1/0.11 | 98.09 | A |
| Oil agent 2 | B1/1.3 | — | D1/0.50 | E1/0.11 | 98.09 | B |
| Oil agent 3 | B1/1.3 | C1/0.65 | D1/0.65 | E1/0.11 | 97.29 | A |
| Oil agent 4 | B1/1.3 | C1/0.65 | D1/0.65 | E1/0.11 | 97.29 | B |
| Oil agent 5 | B1/1.3 | C1/2.5 | D1/0.65 | E1/0.11 | 95.44 | B |
| Oil agent 6 | B1/0.25 | C1/0.65 | D1/0.65 | E1/0.02 | 98.43 | B |
| Oil agent 7 | B1/4.0 | C1/0.65 | D1/0.65 | E1/0.34 | 94.36 | B |
| Oil agent 8 | B1/1.3 | C2/0.65 | D1/0.65 | E1/0.11 | 97.29 | B |
| Comparative | B1/0.05 | C1/0.65 | D1/0.65 | E1/0.005 | 98.69 | B |
| oil agent 1 | | | | | | |
| Comparative | B1/6.0 | C1/0.65 | D1/0.65 | E1/0.5 | 92.20 | B |
| oil agent 2 | | | | | | |

### Production Example A

### Examples 1 and 3

An acrylonitrile-based polymer obtained by copolymerizing 49 mass % of acrylonitrile, 50.5 mass % of vinyl chloride, and 0.5 mass % of sodium styrene sulfonate were dissolved in acetone to prepare a resin solution having a resin concentration of 29.5 mass %. Next, a black pigment (acetone solution, 10.5 mass %) as a coloring agent was added to the resin solution in an amount of 19.2 parts by mass with respect to 100 parts by mass of the acrylonitrile-based polymer to prepare a spinning raw solution. The spinning raw solution was extruded from a spinning nozzle (hole diameter: 0.4 mm, number of holes: 100) into a coagulation bath of 25 mass % of an acetone aqueous solution at 25° C. and wet-spun at a spinning speed of 3 m/min, and then stretched 2.0 times in a stretching bath of 20 mass % of an acetone aqueous solution at 50° C., to obtain the polyacrylonitrile-based synthetic fiber (A). Subsequently, a yarn was washed with hot water at 80° C. while being stretched 1.1 times, immersed for 1 to 2 seconds in an oil agent tank (60° C.) into which each oil agent described in Table 1 was introduced, and impregnated with the oil agent, and then the oil agent was squeezed by a nip roll so that 20 mass % of the oil agent is attached to the polyacrylonitrile-based synthetic fiber (A). Subsequently, the yarn was dried at 130° C., then stretched 2.1 times, and subjected to 8% relaxation shrinkage under heat treatment conditions at 150° C. for 90 seconds to prepare water-repellent polyacrylonitrile-based artificial hair fibers having a single fiber fineness of about 46 dtex of Examples 1 and 3 described in the following Table 2.

### Production Example B

### Examples 2, 4 to 8, and Comparative Examples 1 and 2

100 g of modacrylic fibers (“AFRELLE” manufactured by Kaneka Corporation, 46 dtex), which are a headdress product, were washed with hot water at 60° C. and then dried at room temperature for one day. Next, the polyacrylonitrile-based synthetic fiber (A) after being dried was immersed for 5 minutes in the oil agent tank (60° C.) into which each oil agent described in Table 1 was introduced, a fiber bundle was impregnated with an oil agent composition containing a water repellent, and then an amount of the oil agent attached was adjusted using a small stretching dehydrator so that the amount of the oil agent was 20 mass % with respect to the mass of the fiber bundle. Subsequently, both ends of the fiber bundle were fixed, and heated at 150° C. for 40 minutes, followed by drying and heat treatment to prepare water-repellent polyacrylonitrile-based artificial hair fibers of Examples 2 and 4 to 8 and Comparative Examples 1 to 2.

In Table 2, amounts “gowf” of the water repellent (B), the modified silicone (C), the antistatic agent (D), and the water-repellent aid (E) attached mean the mass % of the water repellent (B), the modified silicone (C), or the antistatic agent (D), with respect to a total mass of the polyacrylonitrile-based synthetic fiber (A). The amounts of the water repellent (B), the modified silicone (C), and the antistatic agent (D) attached were calculated based on extraction amounts of the respective components obtained by extracting the water repellent (B), the modified silicone (C), and the antistatic agent (D) from a water-repellent polyacrylonitrile-based artificial hair fiber after the water-repellent polyacrylonitrile-based artificial hair fiber was prepared.

### Evaluation

The obtained water-repellent polyacrylonitrile-based artificial hair fiber was evaluated for a water repellency and texture according to the following method. Results are shown in Table 2.

### Water Repellency

A fiber bundle with a total fineness of 1,242,000 dtex was prepared and cut into 10 cm, and a portion of 1 cm from one end was fixed with a binding band. Next, distilled water was added to a 500 ml container up to an edge thereof, and the entire fiber bundle was immersed in water with an end of the fiber bundle fixed with the binding band facing up, and an upper portion of the container was closed to prevent the fiber bundle from coming out of a water surface. A time taken for the fiber bundle to settle to a bottom of the container was measured. When the water repellency is high, water slowly permeates into a center of the fiber bundle, and thus it takes a long time for the fiber bundle to settle to the bottom of the container. The water repellency was evaluated as follows based on the time until the fiber bundle is settled.

30 minutes or longer: high water repellency is observed (o)

3 minutes or longer and less than 30 minutes: water repellency is observed (Δ)

less than 3 minutes: no sufficient water repellency is observed (x)

### Texture

Three or more people who have been engaged in a hairpiece beauty evaluation for three years or longer perform a sensory evaluation using a fiber bundle sample having a total fineness of 1,200,000 dtex to 1,300,000 dtex, and comprehensively determine texture such as softness, sliminess, and moistness based on the following three criteria as compared with AFRELLE (modacrylic fiber manufactured by Kaneka Corporation, 46 dtex).
A (very good): having a better texture than AFRELLE.
B (good): having texture equivalent to that of AFRELLE.
C (poor): having a poorer texture than AFRELLE.

TABLE 2

| | | | | | Water | | | |
|---|---|---|---|---|---|---|---|---|
| | | Water | Modified | Antistatic | repellent | | | |
| | | repellent (B) | silicone (C) | agent (D) | aid (E) | Water Repellency | | |
| | | Type/ [symbol] | Type/ [symbol] | Type/ [symbol] | Type/ [symbol] | Settling [symbol] | Evaluation | Texture |
| Example 1 | Oil agent 1 | B1/ [symbol] | — | D1/0.10 | E1/0.022 | [symbol] minutes or longer | ○ | B |
| Example 2 | Oil agent 2 | B1/0.26 | — | D1/0.10 | E1/0.022 | [symbol] minutes or longer | ○ | B |
| Example 3 | Oil agent 3 | B1/0.26 | C1/ [symbol] | D1/ [symbol] | E1/ [symbol] | [symbol] minutes or longer | ○ | A |
| Example 4 | Oil agent 4 | B1/ [symbol] | C1/0.13 | D1/ [symbol] | E1/0.022 | 11 minutes | Δ | A |
| Example 5 | Oil agent 5 | B1/ [symbol] | C1/0.5 | D1/ [symbol] | E1/0.022 | [symbol] minutes | Δ | B |
| Example 6 | Oil agent 6 | B1/0.05 | C1/0.13 | D1/0.13 | E1/ [symbol] | [symbol] minutes | Δ | A |
| Example 7 | Oil agent 7 | B1/ [symbol] | C1/0.13 | D1/0.13 | E1/0.067 | [symbol] minutes | Δ | B |
| Example 8 | Oil agent 8 | B1/ [symbol] | C1/0.13 | D1/ [symbol] | E1/0.022 | 7 minutes | Δ | A |
| Comparative | Comparative | B1/0.01 | C1/0.13 | D1/ [symbol] | E1/ [symbol] | Less than [symbol] minutes | [symbol] | A |
| Example 1 | oil agent 1 | | | | | | | |
| Comparative | Comparative | B1/1.2 | C1/0.13 | D1/ [symbol] | E1/0.100 | [symbol] minutes or longer | ○ | [symbol] |
| Example 2 | oil agent 2 | | | | | | | |

[symbol]

indicates data missing or illegible when filed

Based on Table 2, it can be seen that the water-repellent polyacrylonitrile-based artificial hair fibers of Examples 1 to 8 had a high water repellency while having texture of synthetic hair, and on the other hand, as described in Comparative Examples 1 to 2, when the amount of the water repellent (B) attached was extremely small or exceeds 1.0 mass %, both the texture and the water repellency of the synthetic hair could not be achieved.

### Examples 1A to 18A and Comparative Examples 1A to 2A

### Preparation of Oil Agent

The water repellent (B), the modified silicone (C), the antistatic agent (D), the water-repellent aid (E), and water, which were used in Examples 1 to 8 and Comparative Examples 1 to 2, were mixed in contents described in the following Table 3 to prepare oil agents 1A to 18A and comparative oil agents 1A to 2A, which are oil agent aqueous solutions.

In the oil agents 2A to 10A, the following C3 was used as the modified silicone (C).

C3: epoxy-modified silicone (“MSW-2” manufactured by Matsumoto Yushi-Seiyaku Co., Ltd.)

In the oil agents 17A and 18A, the following D2 and D3 were used as the antistatic agent (D).

D2: guanidine-based cationic antistatic agent (“Nicepole FL” manufactured by Nicca Chemical Co., LTD.)

D3: polyoxyethylene alkyl ether type nonionic antistatic agent (“Nonion K-230” manufactured by NOF CORPORATION)

In addition, in Table 3, “A” and “B” described in the column of “Method of applying oil agent” have the same meanings as “A” and “B” described in the column of “Method of applying oil agent” in Table 1.

### Evaluation

The obtained water-repellent polyacrylonitrile-based artificial hair fiber was evaluated for a water repellency and texture according to the above-described method. In addition, in Examples 8A to 10A and 17A to 18A, a static electricity amount was evaluated according to the following method. Results are shown in Table 4.

### Static Electricity Amount

A fiber bundle with a total fineness of 1,242,000 dtex was prepared and cut into 30 cm, and a portion of 5 cm from one end was fixed with a binding band and left to stand for 1 hour in a constant temperature and humidity chamber at a temperature of 23° C. and a humidity of 50% RH. Next, an upper portion of the fiber bundle was held in the constant temperature and humidity chamber, a plastic comb was passed three times in the fiber bundle, and immediately, a static electricity measuring apparatus (STATIRON DZ4 manufactured by Shishido Electrostatic, Ltd.) was brought close to the fiber bundle to a distance of 5 cm and a static electricity amount was measured. The static electricity amount was evaluated as follows based on values of static electricity.

−6 kV or more and +6 kV or less: static electricity is suppressed (o)

less than −6kV or more than +6kV: strong static electricity is generated (x)

TABLE 3

| | | | | Water | | |
|---|---|---|---|---|---|---|
| | Water | Modified | Antistatic | repellent | | Method of |
| | repellent (B) | silicone (C) | agent (D) | aid (E) | Water | applying |
| | Type/mass % | Type/mass % | Type/mass % | Type/mass % | Mass % | oil agent |
| Oil agent 1A | B1/1.3 | — | D1/0.45 | E1/0.11 | 99.44 | A |
| Oil agent 2A | B1/1.3 | C3/0.016 | D1/0.45 | E1/0.11 | 99.42 | A |
| Oil agent 3A | B1/1.3 | C3/0.033 | D1/0.45 | E1/0.11 | 99.41 | A |
| Oil agent 4A | B1/1.3 | C3/0.065 | D1/0.45 | E1/0.11 | 99.38 | A |
| Oil agent 5A | B1/1.3 | C3/0.25 | D1/0.45 | E1/0.11 | 99.19 | A |
| Oil agent 6A | B1/1.3 | C3/0.65 | D1/0.45 | E1/0.11 | 98.79 | A |
| Oil agent 7A | B1/1.3 | C3/2.5 | D1/0.45 | E1/0.11 | 96.94 | A |
| Oil agent 3A | B1/1.3 | C3/0.065 | D1/0.065 | E1/0.11 | 99.76 | A |
| Oil agent 9A | B1/1.3 | C3/0.065 | D1/0.25 | E1/0.11 | 99.58 | A |
| Oil agent 10A | B1/1.3 | C3/0.065 | D1/0.6 | E1/0.11 | 99.23 | A |
| Oil agent 11A | B1/1.3 | — | — | E1/0.11 | 99.89 | B |
| Oil agent 12A | B1/1.3 | C1/0.25 | — | E1/0.11 | 99.64 | B |
| Oil agent 13A | B1/1.3 | C1/0.65 | — | E1/0.11 | 99.24 | B |
| Oil agent 14A | B1/1.3 | C1/2.5 | — | E1/0.11 | 97.39 | B |
| Oil agent 15A | B1/0.25 | C1/0.65 | — | E1/0.02 | 99.33 | B |
| Oil agent 16A | B1/4.0 | C1/0.65 | — | E1/0.335 | 99.015 | B |
| Comparative | B1/0.05 | C1/0.65 | — | E1/ [symbol] | 99.345 | B |
| oil agent 1A | | | | | | |
| Comparative | B1/6.0 | C1/0.65 | | E1/0.5 | 98.85 | B |
| oil agent 2A | | | | | | |
| Oil agent 17A | B1/1.3 | C3/0.065 | D2/0.45 | E1/0.11 | 99.375 | B |
| Oil agent 18A | B1/1.3 | C3/0.065 | D3/0.45 | E1/0.11 | 99.375 | B |

[symbol]

indicates data missing or illegible when filed

TABLE 4

| | | | | | Water | | | | | | | |
|---|---|---|---|---|---|---|---|---|---|---|---|---|
| | | Water | Modified | Antistatic | repellent | | | | | | | |
| | | repellent (B) | silicone (C) | agent (D) | aid (E) | Ratio | | | Water Repellency | | | |
| | | Type/ [symbol] | Type/ [symbol] | Type/ [symbol] | Type/ [symbol] | [symbol] | [symbol] | [symbol] | [symbol] | Evaluation | [symbol] | [symbol] |
| Example 1A | Oil agent [symbol] | [symbol] | — | [symbol] | [symbol] | [symbol] | — | [symbol] | [symbol] minutes or longer | ○ | [symbol] | — |
| Example 2A | Oil agent [symbol] | [symbol] | [symbol] | [symbol] | [symbol] | [symbol] | [symbol] | [symbol] | [symbol] minutes or longer | ○ | [symbol] | — |
| Example 3A | Oil agent [symbol] | [symbol] | [symbol] | [symbol] | [symbol] | [symbol] | [symbol] | [symbol] | [symbol] minutes or longer | ○ | [symbol] | — |
| Example 4A | Oil agent [symbol] | [symbol] | [symbol] | [symbol] | [symbol] | [symbol] | [symbol] | [symbol] | [symbol] minutes or longer | ○ | [symbol] | — |
| Example 5A | Oil agent [symbol] | [symbol] | [symbol] | [symbol] | [symbol] | [symbol] | [symbol] | [symbol] | [symbol] minutes or longer | ○ | [symbol] | — |
| Example 6A | Oil agent [symbol] | [symbol] | [symbol] | [symbol] | [symbol] | [symbol] | [symbol] | [symbol] | [symbol] minutes | Δ | [symbol] | — |
| Example 7A | Oil agent [symbol] | [symbol] | [symbol] | [symbol] | [symbol] | [symbol] | [symbol] | [symbol] | [symbol] minutes | Δ | [symbol] | — |
| Example 8A | Oil agent [symbol] | [symbol] | [symbol] | [symbol] | [symbol] | [symbol] | [symbol] | [symbol] | [symbol] minutes or longer | ○ | [symbol] | [symbol] |
| Example 9A | Oil agent [symbol] | [symbol] | [symbol] | [symbol] | [symbol] | [symbol] | [symbol] | [symbol] | [symbol] minutes or longer | ○ | [symbol] | [symbol] |
| Example 10A | Oil agent [symbol] | [symbol] | [symbol] | [symbol] | [symbol] | [symbol] | [symbol] | [symbol] | [symbol] minutes or longer | ○ | [symbol] | [symbol] |
| Example 11A | Oil agent [symbol] | [symbol] | — | — | [symbol] | [symbol] | — | — | [symbol] minutes or longer | ○ | [symbol] | — |
| Example 12A | Oil agent [symbol] | [symbol] | [symbol] | — | [symbol] | [symbol] | [symbol] | — | [symbol] minutes or longer | ○ | [symbol] | — |
| Example 13A | Oil agent [symbol] | [symbol] | [symbol] | — | [symbol] | [symbol] | [symbol] | — | [symbol] minutes or longer | ○ | [symbol] | — |
| Example 14A | Oil agent [symbol] | [symbol] | [symbol] | — | [symbol] | [symbol] | [symbol] | — | [symbol] minutes | Δ | [symbol] | — |
| Example 15A | Oil agent [symbol] | [symbol] | [symbol] | — | [symbol] | [symbol] | [symbol] | — | [symbol] minutes | Δ | [symbol] | — |
| Example 16A | Oil agent [symbol] | [symbol] | [symbol] | — | [symbol] | [symbol] | [symbol] | — | [symbol] minutes | Δ | [symbol] | — |
| Comparative | Comparative | [symbol] | [symbol] | — | [symbol] | [symbol] | [symbol] | — | [symbol] minutes | [symbol] | [symbol] | — |
| Example 1A | oil agent [symbol] | | | | | | | | | | | |
| Comparative | Comparative | [symbol] | [symbol] | — | [symbol] | [symbol] | [symbol] | — | [symbol] minutes or longer | ○ | [symbol] | — |
| Example 2A | oil agent [symbol] | | | | | | | | | | | |
| Example 17A | Oil agent 17A | [symbol] | [symbol] | [symbol] | [symbol] | [symbol] | [symbol] | 0.35 | [symbol] minutes or longer | ○ | [symbol] | [symbol] |
| Example 18A | Oil agent 18A | [symbol] | [symbol] | [symbol] | [symbol] | [symbol] | [symbol] | 0.35 | [symbol] minutes or longer | ○ | [symbol] | [symbol] |

[symbol]

indicates data missing or illegible when filed

Based on Table 4, it can be seen that when a mass ratio of the amount of the alkyl (meth)acrylate-based water repellent (B) attached relative to the amount of the modified silicone (C) having a polar substituent attached, (B):(C), ranges between 1:0.03 and 1:0.4 inclusive, both the water repellency and the texture were superior.

In addition, it can be seen that when a mass ratio of the amount of the alkyl (meth)acrylate-based water repellent (B) attached relative to the amount of the antistatic agent (D) attached, (B):(D), ranges between 1:0.15 and 1:0.7 inclusive, both the water repellency and an effect of reducing static electricity were superior.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A water repellent polyacrylonitrile-based artificial hair fiber comprising:
a polyacrylonitrile-based synthetic fiber (A); and
an alkyl (meth)acrylate-based water repellent (B) attached to the polyacrylonitrile-based synthetic fiber (A),
wherein the alkyl (meth)acrylate-based water repellent (B) does not have a fluorine group,
the alkyl (meth)acrylate-based water repellent (B) has a long-chain hydrocarbon side chain, and
an amount of the alkyl (meth)acrylate-based water repellent (B) attached to the polyacrylonitrile-based synthetic fiber (A) is 0.03 mass % or more and 1.0 mass % or less with respect to a total mass of the polyacrylonitrile-based synthetic fiber (A).

2. The water repellent polyacrylonitrile-based artificial hair fiber according to claim 1, further comprising a modified silicone (C) having a polar substituent, wherein
the modified silicone is (C) attached to the polyacrylonitrile-based synthetic fiber (A),
the modified silicone (C) is a dimethylsiloxane polymer substituted with an epoxy group and/or an amino group, and
an amount of the modified silicone (C) attached to the polyacrylonitrile-based synthetic fiber (A) is 0.01 mass % or more and 0.5 mass % or less with respect to the total mass of the polyacrylonitrile-based synthetic fiber (A).

3. The water repellent polyacrylonitrile-based artificial hair fiber according to claim 1, wherein the alkyl (meth)acrylate-based water repellent (B) further comprises a structural unit derived from vinyl chloride.

4. The water repellent polyacrylonitrile-based artificial hair fiber according to claim 1, wherein
an ionic antistatic agent (D1) and/or a nonionic antistatic agent (D2) are/is further attached, as an antistatic agent (D), to the polyacrylonitrile-based synthetic fiber (A), and
an amount of the antistatic agent (D) attached to the polyacrylonitrile-based synthetic fiber (A) is 0.05 mass % or more and 0.4 mass % or less with respect to the total mass of the polyacrylonitrile-based synthetic fiber (A).

5. The water repellent polyacrylonitrile-based artificial hair fiber according to claim 2, wherein
an ionic antistatic agent (D1) and/or a nonionic antistatic agent (D2) are/is further attached, as an antistatic agent (D), to the polyacrylonitrile-based synthetic fiber (A), and
an amount of the antistatic agent (D) attached to the polyacrylonitrile-based synthetic fiber (A) is 0.05 mass % or more and 0.4 mass % or less with respect to the total mass of the polyacrylonitrile-based synthetic fiber (A).

6. The water repellent polyacrylonitrile-based artificial hair fiber according to claim 2, wherein a mass ratio (B):(C) of an amount of the alkyl (meth)acrylate-based water repellent (B) attached to the polyacrylonitrile-based synthetic fiber (A) relative to an amount of the modified silicone (C) attached to the polyacrylonitrile-based synthetic fiber (A) ranges between 1:0.03 and 1:0.4 inclusive.

7. The water repellent polyacrylonitrile-based artificial hair fiber according to claim 4, wherein a mass ratio (B):(D) of the amount of the alkyl (meth)acrylate-based water repellent (B) attached to the polyacrylonitrile-based synthetic fiber (A) relative to an amount of the antistatic agent (D) attached to the polyacrylonitrile-based synthetic fiber (A) ranges between 1:0.15 and 1:0.7 inclusive.

8. The water repellent polyacrylonitrile-based artificial hair fiber according to claim 5, wherein
a mass ratio (B):(C) of the amount of the alkyl (meth)acrylate-based water repellent (B) attached to the polyacrylonitrile-based synthetic fiber (A) relative to the amount of the modified silicone (C) attached to the polyacrylonitrile-based synthetic fiber (A) ranges between 1:0.03 and 1:0.4 inclusive, and
a mass ratio (B):(D) of of an amount the alkyl (meth)acrylate-based water repellent (B) attached to the polyacrylonitrile-based synthetic fiber (A) relative to the amount of the antistatic agent (D) attached to the polyacrylonitrile-based synthetic fiber (A) ranges between 1:0.15 and 1:0.7 inclusive.

9. The water repellent polyacrylonitrile-based artificial hair fiber according to claim 1, wherein a single fiber fineness is 1 dtex or more and 100 dtex or less.

10. A method of producing the water repellent polyacrylonitrile-based artificial hair fiber according to claim 1, the method comprising:
obtaining a coagulated yarn by wet spinning a spinning solution containing an acrylonitrile-based polymer, and
bringing a yarn comprising the coagulated yarn into contact with an oil agent containing the alkyl (meth)acrylate-based water repellent (B), before drying the yarn.

11. A method of producing the water repellent polyacrylonitrile-based artificial hair fiber according to claim 1, the method comprising:
contacting a dried polyacrylonitrile-based synthetic fiber (A) with an oil agent containing the alkyl (meth)acrylate-based water repellent (B) to obtain a contact-treated polyacrylonitrile-based synthetic fiber (A); and
after the contacting with the oil agent, drying a thread of the contact-treated polyacrylonitrile-based synthetic fiber (A).

12. A headdress product comprising the water repellent polyacrylonitrile-based artificial hair fiber according to claim 1.

13. The headdress product according to claim 12, wherein the headdress product is at least one selected from the group consisting of a hair wig, a hairpiece, a weaving, a hair extension, a braid hair, a hair accessory, and a doll hair.
